(19) United States
(12) Patent Application Publication
(10) Pub. No.: US 2026/0266612 A1
(43) Pub. Date: Sep. 10, 2026

(54) NAVIGATION DEVICE, NAVIGATION SYSTEM, NAVIGATION METHOD, AND NAVIGATION PROGRAM

(71) Applicant: FURUNO ELECTRIC CO., LTD, Nishinomiya-City (JP)

(72) Inventor: Kenta OGAWA, Amagasaki (JP)

(73) Assignee: FURUNO ELECTRIC CO., LTD, Nishinomiya-City (JP)

(21) Appl. No.: 19/676,853

(22) Filed: May 14, 2026

Related U.S. Application Data
(63) Continuation of application No. PCT/JP2023/046361, filed on Dec. 25, 2023.

(51) Int. Cl. G01C 21/20; B63B 49/00

(52) U.S. Cl. CPC G01C 21/203; B63B 49/00

(57) ABSTRACT

The navigation device mounted on a ship is provided with processing circuitry. The processing circuitry receives a start position and a destination position associated with the ship, calculates a reversal route from the destination position towards the start position, evaluates a possibility of generation of the reversal route from the destination position to the start position, and determines that the destination position is within a non-navigable area when there is no possibility of the generation of the reversal route.

### CROSS-REFERENCE TO RELATED APPLICATION

This application is a continuation application of PCT International Application No. PCT/JP2023/046361, which was filed on Dec. 25, 2023, the entire disclosure of which is hereby incorporated by reference.

### TECHNICAL FIELD

The present invention relates to a technique for estimating a specific route for a navigation of a ship.

### BACKGROUND

There is a conventional technology that receives a user input corresponding to a route request from a user. Further, the conventional technology generates a route by connecting a position of a ship and a destination endpoint based on the user input.

It is to be noted that, currently, methods for searching a route for a ship using map data, satellite data, weather data are known. Generally, at least one of the map data, the satellite data, and the weather data are analyzed. Further, the route connecting a source location and a destination location is generated based on the analysis of the data. However, it may happen that the route generated based on the analysis of data is a short route, but may not be a route that a user navigating in the area could take. Further, the conventional methods of route searching still requires a user-interaction.

### SUMMARY

However, an optimal route for a ship may not be generated with good accuracy by a conventional method.

Therefore, the purpose of the present invention is to generate the optimal route with high accuracy for the navigation of the ship.

The navigation device to be mounted on a ship of this invention is provided with processing circuitry. In one embodiment, the processing circuitry is configured to receive a start position and a destination position associated with the ship. Further, the processing circuitry is configured to calculate a reversal route from the destination position towards the start position. The destination position is a temporary start position and the start position is a temporary target position for the reversal route. Furthermore, the processing circuitry is configured to evaluate a possibility of generation of the reversal route from the destination position to the start position. Finally, the processing circuitry configured to determine that the destination position is within a non-navigable area when there is no possibility of the generation of the reversal route.

In the navigation device of the present invention, the processing circuitry may expand a plurality of nodes around the destination position, and the evaluation unit is further configured to evaluate the possibility of the generation of the reversal route from the destination position to the start position when at least one of the plurality of nodes for expansion is remaining within an arbitrary range closer to the destination position.

In the navigation device of the present invention, the processing circuitry may evaluate no possibility of generation of the reversal route upon calculating no node for expansion is present within the arbitrary range closer to the destination position.

In the navigation device of the present invention, the processing circuitry may generate an optimal route from the start position to the destination position when the destination position is outside the non-navigable area.

In this configuration, the optimal route from the start position to the destination position is not generated when the destination position is within the non-navigable area.

In the navigation device of the present invention, the processing circuitry may evaluate that there is possibility of the generation of the reversal route when a time required for the calculation process of the reversal route is greater than a predetermined amount of time.

In this configuration, the non-navigable area is a closed area.

In this configuration, the non-navigable area is one of small lakes surrounded by land, and oceans surrounded by shallow water and the like.

In another aspect of the present disclosure, a navigation method is provided. The navigation method comprises receiving a start position and a destination position associated with the ship. The navigation method further comprises calculating a reversal route from the destination position towards the start position. The destination position is a temporary start position and the start position is a temporary target position for the reversal route. Further, the navigation method comprises evaluating a possibility of generation of the reversal route from the destination position to the start position. Finally, the navigation method comprises determining that the destination position is within a non-navigable area when there is no possibility of the generation of the reversal route.

In yet another aspect of the present disclosure, there is provided a navigation program, causing a computer to execute processing configured to receive a start position and a destination position associated with the ship, calculate a reversal route from the destination position towards the start position. The destination position is a temporary start position and the start position is a temporary target position for the reversal route. Further, the processing is configured to evaluate a possibility of generation of the reversal route from the destination position to the start position, and determine that the destination position is within a non-navigable area when there is no possibility of the generation of the reversal route.

The navigation system of the present invention is provided with the navigation device described above and a control unit. In one embodiment, a temporary route is generated to check whether a goal position is inside a non-navigable area, and then the optimal route for the ship is generated.

The navigation device of the present invention enables generation of an optimal route for the ship from a start position to a destination position. The navigation device of the present invention further enables evaluation of a possibility of generation of a reversal route from the destination position to the start position. Based on the possibility of the generation of the reversal route, the navigation device of the present invention determines whether the destination position is within or outside a non-navigable area. It is to be noted that the evaluation of the reversal route in advance helps to determine if the generation of the optimal route is possible or not. Further, the navigation device of the present invention helps to solve the problem that routing cannot be completed because the destination position is set in the non-navigable area, causing a large wait time.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a functional block diagram of a navigation device according to an embodiment of the present invention;

FIG. 2 is a functional block diagram of a navigation system according to an embodiment of the present invention;

FIG. 3 shows a graph displaying calculation of a reversal route according to an embodiment of the present invention;

FIG. 4A illustrates an exemplary embodiment of evaluation of a destination position according to an embodiment of the present invention;

FIG. 4B illustrates another exemplary embodiment of evaluation of the destination position according to an embodiment of the present invention;

FIG. 5 is a flowchart of a navigation method according to an embodiment of the present invention;

FIG. 6 is a flow chart showing an example of the navigation device according to an embodiment of the present invention.

### DETAILED DESCRIPTION

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

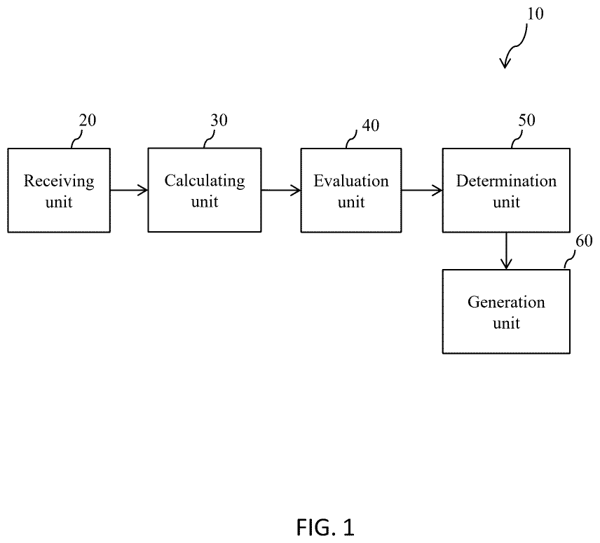

The navigation technology of the embodiment of the present invention will be described with reference to the figures. FIG. 1 is a functional block diagram of a navigation device according to an embodiment of the present invention.

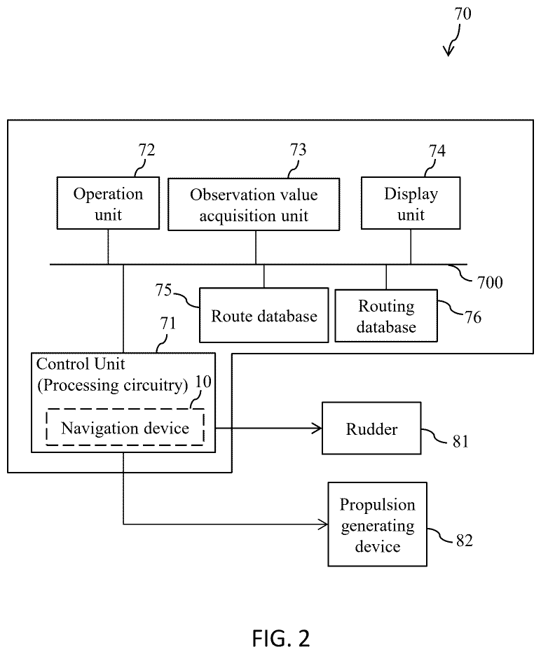

(Schematic configuration of the navigation device 10) As shown in FIG. 1, the navigation device 10 includes a receiving unit 20, a calculating unit 30, an evaluation unit 40, a determination unit 50, and a generation unit 60. FIG. 2 is a functional block diagram of a navigation system according to an embodiment of the present invention. As shown in FIG. 2, the navigation system 70 includes a control unit (processing circuitry) 71, an operation unit 72, an observation value acquisition unit 73, a display unit 74, a route database 75, and a routing database 76. In one embodiment, the navigation device 10 is mounted on a ship.

Referring to FIGS. 1-2, the receiving unit 20 receives a start position and a destination position associated with the ship. The start position indicates coordinates of a starting location associated with the ship. The destination position indicates coordinates of a destination location associated with the ship. The destination position may be referred to as a target position, an end position, or a goal position. In one embodiment, the start position of the ship indicates a current location of the ship. The current location of the ship is determined using at least one of a sensor, a Global Positioning System (GPS), and inputs from a user. Further, the destination position of the ship is received based on a user input. The user input may be received as one of a text input, a touch input, and the like. In one embodiment, the start position and the destination position may be received based on the user input. The user may be an operator operating the navigation device 10 of the ship.

Further, the calculating unit 30 is configured to calculate a reversal route from the destination position towards the start position of the ship. In one embodiment, the destination position is referred as a temporary start position and the start position is referred as a temporary target position for the reversal route. In one embodiment, the reversal route for the ship is an opposite direction route that starts from the destination position and ends at the start position of the ship. The reversal route may be referred to as a temporary route for the ship.

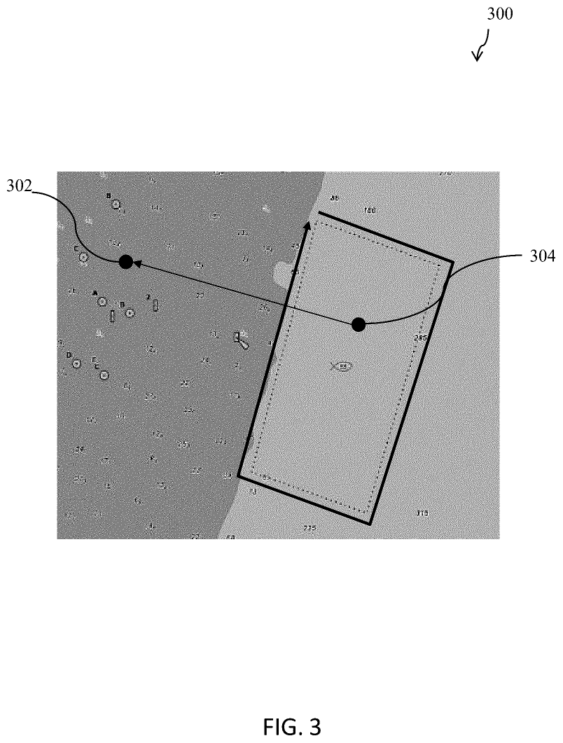

Referring now to FIG. 3, a graph 300 displaying calculation of the reversal route is shown, according to an embodiment of the present invention. In one embodiment, the start position 302 and the destination position 304 are received. Further, the calculating unit 30 is configured to calculate the reversal route from the destination position 304 to the start position 302.

Referring again to FIG. 1, the receiving unit 20 is configured to receive a node associated with each of the start position and the destination position of the ship. The node may be received from an overlapping database. In one embodiment, the overlapping database comprises the overlapping of each route from a plurality of routes, stored in a route database 75, on vertex data stored in a routing database 76. The overlapping database provides multiple nodes and links associated with two or more waypoints of each route from the plurality of routes. In one embodiment, the route database stores data associated with the plurality of routes generated and recommended for the ship. Each route that is recommended for the ship may be referred as a recommended route. The routing database 76 stores vertex data that includes multiple nodes and multiple links connecting the multiple nodes. The vertex data may be referred to as mesh data. In one embodiment, the mesh data and the vertex data are mutually convertible. Further, a center of a mesh is a vertex, and adjacent vertices are connected to each other.

Further, the calculating unit 30 is further configured to expand a plurality of nodes (i.e., nodes) around the destination position within an arbitrary range closer to the destination position. The arbitrary range may be referred to as a predefined radius around the destination position. Further, based on the expansion of the node of the destination position, the plurality of nodes (i.e., node candidates) are generated. The node of the destination position is expanded to determine whether the destination position is within or outside a non-navigable area. In one embodiment, the non-navigable area is a closed area. In one embodiment, the non-navigable area is one of, small lakes surrounded by land, and oceans surrounded by shallow water and the like. In one example, the non-navigable area is a coastline area.

In one exemplary embodiment, assume the expansion of a node around the destination position until the predefined radius closer to the destination position. In one embodiment, if the node is not extended to the predefined radius, then the destination position is within the non-navigable area. In another embodiment, if the node is extended beyond the predefined radius, then the destination position is outside the non-navigable area.

Subsequently, the evaluation unit 40 is configured to evaluate a possibility of generation of the reversal route from the destination position to the start position. In one embodiment, the possibility of the generation of the reversal route is one of a positive possibility and a negative possibility. The positive possibility indicates that there is the possibility of generation of the reversal route. The negative possibility indicates that there is no possibility of generation of the reversal route.

In one embodiment, the possibility of generation of the reversal route is evaluated based on the expansion of the nodes around the destination position. In one embodiment, the evaluation unit 40 evaluates that there is the possibility of generation of the reversal route from the destination position to the start position when at least one node for expansion is remaining. In another embodiment, the evaluation unit 40 evaluates that there is no possibility of generation of the reversal route upon calculating no node for expansion is present within the arbitrary range closer to the destination position.

Further, the determination unit 50 is configured to determine that the destination position is within the non-navigable area when there is no possibility of the generation of the reversal route. In one embodiment, if there is the possibility of generating the reversal route (i.e., at least one node for expansion is present) then the determination unit 50 is configured to determine that the destination position is outside the non-navigable area. In another embodiment, if there is no possibility of generating the reversal route (i.e., no node for expansion is present) then the determination unit 50 is configured to determine that the destination position is within the non-navigable area.

In one embodiment, the process of calculating the reversal route from the destination position to the start position is referred as a pre-routing process. Further, the process of generating an optimal route for the ship from the start position to the destination position, after the pre-routing process, is a routing process. The determination unit 50 is further configured to terminate the routing process when the destination position is within the non-navigable area. Further, the determination unit 50 is configured to continue the routing process when the destination position is outside the non-navigable area.

In one embodiment, wherein the evaluation unit 40 is further configured to evaluate that there is the possibility of the generation of the reversal route when a time required for the calculation process of the reversal route is greater than a predetermined amount of time. In one embodiment, the process of determining that the destination position is outside the non-navigable area may be based on a distance or a processing time.

In one embodiment, during the generation of the reversal route, the predefined radius is defined as a distance for expanding the plurality of nodes. The plurality of nodes (also referred to as nodes) are repeatedly expanded from the destination position. If the distance between the expanded node and the destination position exceeds the predefined radius, there is the possibility of generating the reversal route. If there are no nodes to be expanded before reaching the predefined radius, there is no possibility of generating the reversal route.

In one embodiment, a predefined time from the start of the generation of the reversal route is defined as a node expansion time. The nodes are repeatedly expanded from around the destination position, and if the processing time reaches the node expansion time, there is the possibility of generating the reversal route. If there are no nodes to be expanded before reaching the node expansion time, there is no possibility of generating the reversal route.

Subsequently, the generation unit 60 is configured to generate the optimal route from the start position to the destination position when the destination position is outside the non-navigable area. In one embodiment, the optimal route from the start position to the destination position is not generated when the destination position is within the non-navigable area.

The generation unit 60 is further configured to generate the optimal route using a shortest path search technique. The shortest path search technique is one of a Dijkstra's technique, a bidirectional Dijkstra's technique, an A* technique, Bellman-ford technique, and an ant colony optimization technique. It will be understood to a person skilled in the art that in alternate embodiments, any suitable shortest path search technique apart from the aforementioned techniques may be utilized to generate the optimal route for the ship, without deviating from the scope of the present disclosure.

In one embodiment, the generation unit 60 generates the plurality of routes connecting the start position and the destination position using a plurality of waypoints. The plurality of routes are stored in the route database 75. The plurality of routes may include multiple recommended routes. Each route from the plurality of routes include at least one of a first subset of routes and a second subset of routes. The first subset of routes comprise at least a portion of a recommended route from the multiple routes. The second subset of routes comprises routes excluding the recommended route. In one embodiment, the first subset of routes comprise combination of a portion of other routes excluding the recommended route and at least the portion of the recommended route. The first subset of routes may comprise the recommended route.

Further, a cost associated with the plurality of routes and a cost associated with the recommended route is determined. In one embodiment, the cost between two waypoints in the recommended route is determined based on multiplying a distance between the two waypoints by an arbitrary value less than one. The cost of the recommended route is determined based on multiplying the distance between the two waypoints of the recommended route by the arbitrary value less than one. In one embodiment, the arbitrary value less than one is predefined. In one embodiment, a first technique may comprise determination of the cost of the recommended route by multiplying the distance between the two waypoints of the recommended route by the arbitrary value less than one.

Further, the cost between two waypoints excluding the recommended route based on multiplying a distance between the two waypoints by an arbitrary value greater than one. The cost of the other routes excluding the recommended route is determined based on multiplying the distance between the two waypoint by the arbitrary value greater than one. In one embodiment, the arbitrary value greater than one is predefined. In one embodiment, a second technique may comprise determination of the cost of the recommended route by multiplying the distance between the two waypoints of the other route by the arbitrary value greater than one. In one embodiment, the cost of each route from the plurality of routes is determined using one of the first technique and the second technique.

Once the cost of each route is determined, the cost of each route from the plurality of routes connecting the start position and the destination position may be compared. In one embodiment, the cost of the two or more waypoints of the recommended route and the cost of the multiple waypoints of the other routes excluding the recommended route are compared. In another embodiment, the cost of each route from the first subset of routes and the second subset of routes connecting the start point and the end point is compared. Based on the comparison of the costs, the optimal route between the start position and the destination position of the ship is generated.

Further, the generation unit 60 generates the optimal route based on the cost of the plurality of routes and the cost of the recommended route. In one embodiment, the optimal route is generated based on the comparison of the costs. The optimal route corresponds to a shortest distance route between the start position and the destination position. The optimal route indicates a low cost route from the start position to the destination position of the ship. In one embodiment, the cost of the recommended route is relatively less than the cost of the other routes from the plurality of routes. Further, a smoothing technique may be applied on the optimal route except the portion of the recommended route. In one embodiment, the smoothing technique is applied on the portion of the optimal route that connects the ends of the recommended route to the start position and the end position. The smoothing technique helps to make the optimal route smoother, thereby reducing the distance to be travelled.

Referring to FIG. 2, the navigation system 70 is mounted on the ship performing, for example, an autopilot control (automatic navigation control).

The control unit 71 is connected to a rudder 81 and a propulsion generating unit 82. The rudder 81 and the propulsion generating unit 82 are mounted on a hull of the ship. The control unit 71, the rudder 81, and the propulsion generating unit 82 are connected, for example, via analog voltage or data communication.

The control unit 71, the operation unit 72, the observation value acquisition unit 73, the display unit 74, the route database 75, and the routing database 76 are connected to each other by, for example, a data communication network 700 for ships.

The operation unit 72 is realized by, for example, a touch panel, physical buttons or switches. The operation unit 72 accepts the operation of settings related to the autopilot control.

The observation value acquisition unit 73, realized by various sensors, acquires state data indicating the state of the ship such as its own position, the end point, the heading, a ship speed, a response angular speed, and a rudder angle.

The display unit 74, for example, is realized by a liquid crystal panel or the like. When information or the like related to the autopilot control is input from the control unit 71, for example, the display unit 74 displays the information i.e., the optimal route between the start position and the destination position of the ship. In one embodiment, the display unit 74 displays the calculation of the reversal route from the destination position to the start position, the optimal route for the ship, the recommended route for the ship, and the like. Although it is possible to omit the display unit 74, it is preferable to have it, and the presence of the display unit 74 allows the user to easily grasp the autopilot control status, etc.

The control unit 71 generates and stores the route information of the ship as described above. That is, the control unit 71 includes the configuration of the navigation device 10 described above.

The control unit 71 performs autopilot control by a known method based on the operation input from the operation unit 72 and the state data from the observation value acquisition unit 73. The control unit 71 controls the steering angle of the rudder 81 and the propulsive force of the propulsion generating unit 82 by the autopilot control.

In one embodiment, the control unit 71 receive the start position and the destination position associated with the ship. The control unit 71 further calculates the reversal route from the destination position towards the start position. Further, the control unit 71 evaluates the possibility of generation of the reversal route from the destination position to the start position. Furthermore, the control unit 71 determines that the destination position is within the non-navigable area when there is no possibility of the generation of the reversal route. Subsequently, the control unit 71 generates the optimal route between the start position and the end position when the destination position is outside the non-navigable area. The control unit 71 performs rudder angle control and propulsion control based on the distances and directions, as well as the current ship speed, bow direction, motion characteristics of the ship, pier position and pier position.

In this case, the control unit 71 may display the optimal route on the display unit 74.

With this, the navigation system 70 may assist the ship in finding the optimal route between the start position and the destination position using the pre-routing process. Therefore, the pre-routing process helps to reduce a time required for generation of optimal route.

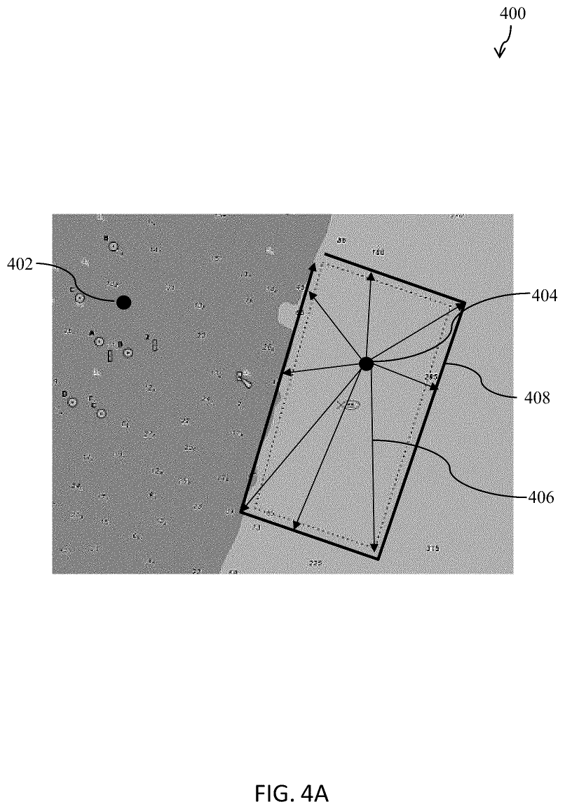

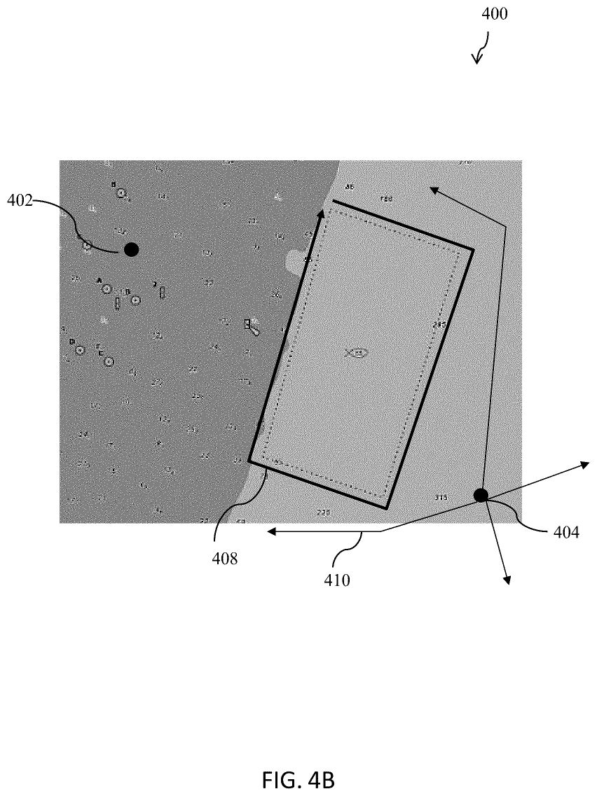

Referring to FIG. 4A, an exemplary embodiment 400 of evaluation of the destination position is illustrated, according to an embodiment of the present invention. In the exemplary embodiment, the calculating unit 30 is configured to calculate the reversal route from the destination position 404 to the start position 402. Further, the evaluation unit 40 is configured to expand the nodes around the destination position within the arbitrary range closer to the destination position 404. The arbitrary range may be referred to as the predefined radius around the destination position. In this exemplary embodiment, the evaluation unit 40 evaluates that there is no node available for immediate deployment and hence the routing process is terminated. Thus, the determination unit 50 determines that the destination position is within the non-navigable area 408, when no node for expansion is available. Further, the determination unit 50 determines that the optimal route from the start position to the destination position may not be generated when the destination position is within the non-navigable area. In one embodiment, if the destination position is surrounded by the coastline area (i.e., the non-navigable area), there are no nodes available for immediate deployment and the routing process fails. Hence, the routing from the start position to the destination position is considered unreachable.

In one embodiment, the destination position is surrounded by the non-navigable area, hence OpenList turns null soon. If the route (i.e., the reversal route) from the destination position to the start position is not found, the computation of the route (i.e., the optimal route) for the ship is canceled.

In one embodiment, the OpenList is a term used in an A* pathfinding algorithm. The OpenList may be rephrased as a list of expandable node candidates. The A* pathfinding algorithm includes expanding the nodes connected to a particular node. Further, the expanded nodes are placed in the OpenList. Furthermore, one node from the OpenList is identified that is considered to be closest to the destination position. Subsequently, the nodes are further expanded, and the process is repeated. Further, when the OpenList becomes null, it means there are no candidate routes left for expansion, and it is no longer possible to continue searching for the routes.

Referring now to FIG. 4B, another exemplary embodiment 400 of evaluation of the destination position is illustrated, according to an embodiment of the present invention. In the exemplary embodiment, the calculating unit 30 is configured to calculate the reversal route from the destination position 404 to the start position 402. Further, the evaluation unit 40 is configured to expand the nodes around the destination position within the arbitrary range closer to the destination position. Furthermore, the evaluation unit 40 is configured to evaluate the possibility of generation of the reversal route from the destination position to the start position based on the expansion of the nodes. The determination unit 50 is further configured to determine that the destination position is outside the non-navigable area 408 based on the possibility of generation of the reversal route. In the exemplary embodiment, there are nodes or at least one node for expansion is present in the arbitrary range upon around the destination position, and hence it indicates that there is the possibility to generate the reversal route.

In one embodiment, if the destination position is not surrounded by the non-navigable area 408, then the node expansion candidates do not run out immediately. In other words, if there is at least one node for expansion is present in the arbitrary range, then the destination position is outside the non-navigable area.

In one embodiment, the determination unit 50 is configured to determine that the destination position is not surrounded by the non-navigable at least within a radius of x NM, when the node with radius x NM is expanded from the destination position. Thus, the process of the temporary routing is terminated upon determining that the destination position is outside the non-navigable area. Further, the generation unit 60 is configured to generate the optimal route from the start position 402 to the destination position 404.

In one embodiment, the determination that the destination position is not surrounded by the non-navigable area may be based on a distance or a processing time. The evaluation unit 40 is further configured to evaluate that there is possibility of the generation of the reversal route when the time required for the calculation process of the reversal route is greater than the predetermined amount of time.

In one embodiment, the navigation device 10 is configured to perform routing in a reverse direction in advance by calculating the reversal route from the destination position to the start position. The calculation of the reversal route in advance may be referred to as a pre-routing process. Further, the navigation device 10 is configured to generate the optimal route for the ship from the start position to the destination position based on the pre-routing process. In one embodiment, the optimal route for the ship may be generated, when the destination position is outside the non-navigable area. In another embodiment, the optimal route for the ship may not be generated when the destination position is within the non-navigable area. The generation of the reversal route helps to determine that the route (i.e., the optimal route) for the ship cannot be completed because the destination position is in the non-navigable area, causing a large wait time.

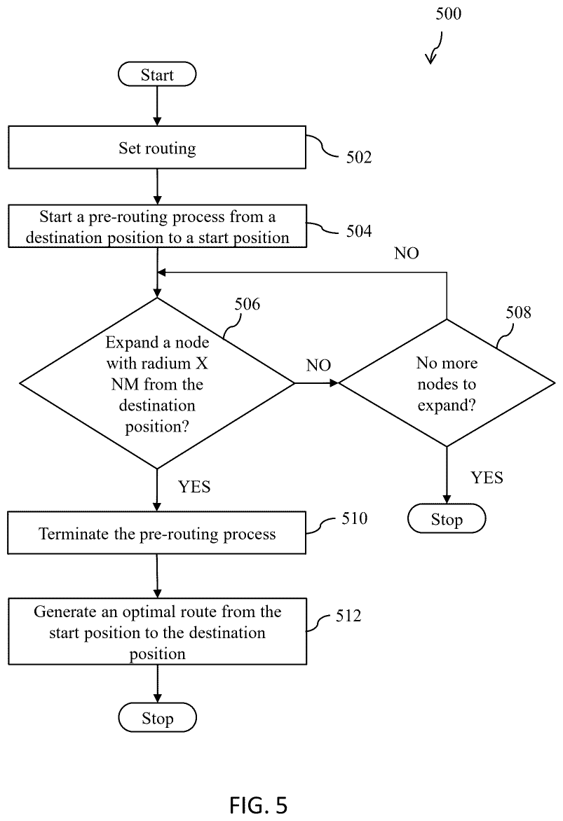

Referring now to FIG. 5, a flowchart 500 of a navigation method is illustrated according to an embodiment of the present invention. At block 502, the receiving unit 20 is configured to receive the start position and the destination position associated with the ship. Once the start position and the destination position are received, the process of generating the route (i.e., the optimal route) for the ship starts.

At block 504, the calculating unit 30 is configured to start the pre-routing process that include calculating the reversal route from the destination position to the start position. The reversal route is the temporary route. The destination point may be the temporary start position and the start position may be the temporary destination position.

At block 506, the evaluation unit 40 is configured to expand the nodes around the destination position within the arbitrary range closer to the destination position. In one embodiment, the nodes around the destination node is extended with the radius x NM. Further, the evaluation unit 40 is configured to evaluate the possibility of the generation of the reversal route based on the expansion of the nodes.

At block 508, the evaluation unit 40 is configured to evaluate that no node for expansion is present closer to the destination position. Further, the evaluation unit 40 evaluates that there is no possibility of the generation of the reversal route when there is no node for expansion is present. If no node is present for the expansion, then process for routing may be terminated. Furthermore, the determination unit 50 determines that the destination position is within the non-navigable area, when no node for expansion is present. In other words, determination unit 50 determines that the destination position is within the non-navigable area when there is no possibility of generation of the reversal route.

At block 510, the evaluation unit 40 is configured to determine at least one node for expansion is present within the arbitrary range closer to the destination position. Further, the evaluation unit 40 determines that there is the possibility of generation of the reversal route, when there is at least one node present for expansion. Furthermore, the determination unit 50 determines that the destination position is outside the non-navigable area, when there is the possibility of the generation of the reversal route. If at least one node for the expansion is present, then the process of pre-routing is stopped, and the optimal route is generated for the ship. In one embodiment, the generation route 60 is configured to generate the optimal route for the ship from the start position to the destination position. The optimal route is the shortest route from the start position to the destination position.

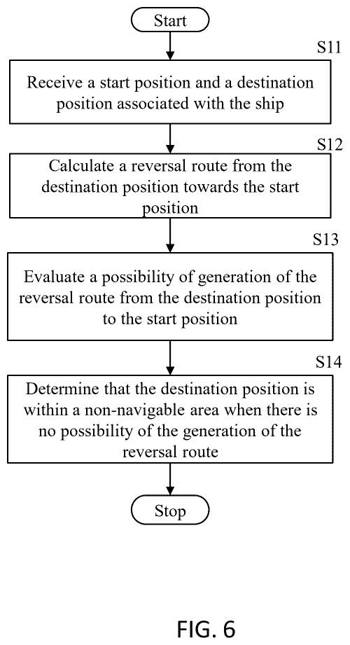

(Navigation device) FIG. 6 is a flow chart showing an example of the navigation device according to an embodiment of the present invention.

It should be noted that the specific details of each process in the flow chart shown in FIG. 6 have been described with the explanation of the configuration described above, so explanation will be omitted below except where necessary.

The navigation device 10 receives the start position and the destination position associated with the ship (S11). Further, the navigation device 10 calculates the reversal route from the destination position towards the start position. The destination position is a temporary start position and the start position is a temporary target position for the reversal route (S12).

Furthermore, the navigation device 10 evaluates the possibility of generation of the reversal route from the destination position to the start position (S13).

Subsequently, the navigation device 10 determines that the destination position is within the non-navigable area when there is no possibility of the generation of the reversal route (S14).

### Terminology

It is to be understood that not necessarily all objectives or advantages may be achieved in accordance with any particular embodiment described herein. Thus, for example, those skilled in the art will appreciate that certain embodiments may be configured to operate in a manner that achieves or optimizes one advantage or group of advantages as taught herein without necessarily achieving other objects or advantages as may be taught or suggested herein.

All processes described herein may be embodied in, and fully automated via, software code modules executed by a computing system that includes one or more computers or processors. The software code modules may be stored in any type of non-transitory computer-readable medium or other computer storage device. Some or all methods may be embodied in specialized computer hardware.

Many other variations other than those described herein will be apparent from this disclosure. For example, depending on the embodiment, certain actions, events, or functions of any of the algorithms described herein may be performed in different sequences, and may be added, merged, or excluded altogether (e.g., not all described actions or events are required to execute the algorithm). Moreover, in certain embodiments, operations or events are performed in parallel, for example, through multithreading, interrupt handling, or through multiple processors or processor cores, or on other parallel architectures, rather than sequentially. In addition, different tasks or processes can be performed by different machines and/or computing systems that can work together.

The various exemplary logical blocks and modules described in connection with the embodiments disclosed herein can be implemented or executed by a machine such as a processor. The processor may be a microprocessor, but alternatively, the processor may be a controller, a microcontroller, or a state machine, or a combination thereof. The processor can include an electrical circuit configured to process computer executable instructions. In another embodiment, the processor includes an application specific integrated circuit (ASIC), a field programmable gate array (FPGA), or other programmable device that performs logical operations without processing computer executable instructions. The processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, the processor may also include primarily analog components. For example, some or all of the signal processing algorithms described herein may be implemented by analog circuitry or mixed analog and digital circuitry. A computing environment may include any type of computer system, including, but not limited to, a computer system that is based on a microprocessor, mainframe computer, a digital signal processor, a portable computing device, a device controller, or a computing engine within the device.

Unless otherwise stated, conditional languages such as “can,” “could,” “will,” “might,” or “may”; are understood within the context as used in general to convey that certain embodiments include, while other embodiments do not include, certain features, elements and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive languages, such as the phrase “; at least one of X, Y, or Z,”; unless specifically stated otherwise, is understood with the context as used in general to present that an item, term, etc., may be either X, Y, or Z, or any combination thereof (e.g., X, Y, and/or Z). Thus, such a disjunctive language is not generally intended to, and should not, imply that certain embodiments require at least one of X, at least one of Y, or at least one of Z to each be present.

Any process descriptions, elements, or blocks in the flow diagrams described herein and/or shown in the accompanying drawings should be understood as potentially representing modules, segments, or parts of code, including one or more executable instructions for implementing a particular logical function or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

As used herein, the terms “attached,” “connected,” “coupled,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A navigation device to be mounted on a ship, the navigation device comprising: processing circuitry configured to:
receive a start position and a destination position associated with the ship;
calculate a reversal route from the destination position towards the start position, wherein the destination position is a temporary start position and the start position is a temporary target position for the reversal route;
evaluate a possibility of generation of the reversal route from the destination position to the start position; and
determine that the destination position is within a non-navigable area when there is no possibility of the generation of the reversal route.

2. The navigation device according to claim 1, wherein the processing circuitry is further configured to:
expand a plurality of nodes from the destination position, and wherein
evaluate the possibility of the generation of the reversal route from the destination position to the start position when at least one of the plurality of nodes for expansion remains within an arbitrary range closer to the destination position.

3. The navigation device according to claim 1, wherein the processing circuitry is further configured to:
evaluate that there is no possibility of generation of the reversal route upon calculating no node for expansion is present within the arbitrary range closer to the destination position.

4. The navigation device according to claim 1, wherein the processing circuitry is further configured to:
generate an optimal route from the start position to the destination position when the destination position is outside the non-navigable area.

5. The navigation device according to claim 1, wherein the optimal route from the start position to the destination position is not generated when the destination position is within the non-navigable area.

6. The navigation device according to claim 1, wherein the processing circuitry is further configured to:
evaluate that there is the possibility of the generation of the reversal route when a time required for the calculation process of the reversal route is greater than a predetermined amount of time.

7. The navigation device according to claim 1, wherein the non-navigable area is a closed area.

8. The navigation device according to claim 1, wherein the non-navigable area is one of small lakes surrounded by land, and oceans surrounded by shallow water.

9. The navigation device according to claim 2, wherein the processing circuitry is further configured to:
evaluate that there is no possibility of generation of the reversal route upon calculating no node for expansion is present within the arbitrary range closer to the destination position.

10. The navigation device according to claim 2, wherein the processing circuitry is further configured to:
generate an optimal route from the start position to the destination position when the destination position is outside the non-navigable area.

11. The navigation device according to claim 9, wherein the optimal route from the start position to the destination position is not generated when the destination position is within the non-navigable area.

12. The navigation device according to claim 11, wherein the processing circuitry is further configured to:
evaluate that there is the possibility of the generation of the reversal route when a time required for the calculation process of the reversal route is greater than a predetermined amount of time.

13. The navigation device according to claim 12, wherein the non-navigable area is a closed area.

14. A navigation method comprising:
receiving a start position and a destination position associated with the ship;
calculating a reversal route from the destination position towards the start position, wherein the destination position is a temporary start position and the start position is a temporary target position for the reversal route;
evaluating a possibility of generation of the reversal route from the destination position to the start position; and
determining that the destination position is within a non-navigable area when there is no possibility of the generation of the reversal route.

15. The navigation method according to claim 14, further comprising:
expanding a plurality of nodes from the destination position; and
evaluating the possibility of the generation of the reversal route from the destination position to the start position when at least one of the plurality of nodes for expansion remains within an arbitrary range closer to the destination position.

16. The navigation method according to claim 14, further comprises evaluating that there is no possibility of generation of the reversal route upon calculating no node for expansion is present within the arbitrary range closer to the destination position.

17. The navigation method according to claim 14, further comprises:
generating an optimal route from the start position to the destination position when the destination position is outside the non-navigable area.

18. The navigation method according to claim 14, wherein the optimal route from the start position to the destination position is not generated when the destination position is within the non-navigable area.

19. The navigation method according to claim 14, further comprises evaluating that there is the possibility of the generation of the reversal route when a time required for the calculation process of the reversal route is greater than a predetermined amount of time.

20. A navigation program, causing a computer to execute processing configured to:
receive a start position and a destination position associated with the ship;
calculate a reversal route from the destination position towards the start position, wherein the destination position is a temporary start position and the start position is a temporary target position for the reversal route;
evaluate a possibility of generation of the reversal route from the destination position to the start position; and
determine that the destination position is within a non-navigable area when there is no possibility of the generation of the reversal route.
